(19) United States
(12) Patent Application Publication
(10) Pub. No.: US 2019/0098913 A1
(43) Pub. Date: Apr. 4, 2019

(54) STABILIZED CANOLA OIL INCLUDING POLYUNSATURATED FATTY ACIDS AND OIL-SOLUBLE ANTIOXIDANTS

(71) Applicant: CARGILL, INCORPORATED, WAYZATA, MN (US)

(72) Inventor: Amir Hossein SABERI, Mount Arlington, NJ (US)

(21) Appl. No.: 16/083,061

(22) PCT Filed: Mar. 8, 2017
(86) PCT No.: PCT/US2017/021260

§ 371 Date: Sep. 7, 2018

Related U.S. Application Data
(60) Provisional application No. 62/305,128, filed on Mar. 8, 2016.

(51) Int. Cl. A23D 9/013; A23L 33/115; A23L 33/105

(52) U.S. Cl. CPC A23D 9/013; A23L 33/115; A23L 33/105; A23V 2250/1842; A23V 2200/02; A23V 2250/214; A23V 2002/00

(57) ABSTRACT

Stabilized oils including an canola oil including EPA and/or DHA and an oil-soluble antioxidant composition comprising rosemary extract and least one of green tea extract, lecithin, and sesamol. The stabilized oils may have an Oxidative Stability Index (“OSI”) at 110° C. of at least 5 hours.

### TECHNICAL FIELD

The present disclosure relates generally to a stabilized canola oil including polyunsaturated fatty acids and an antioxidant composition and methods of making the same.

### BACKGROUND

Rancidification of edible oils and fats, as well as the foods that contain edible oils and fats, is a significant problem in food industries. This is particularly the case because of the increasing emphasis on the use of polyunsaturated oils due to their perceived health benefits, as the oxidative stability of a fatty acid generally decreases noticeably as the degree of unsaturation increases.

Omega-3 fatty acids, also referred to as n-3 fatty acids, are polyunsaturated fatty acids having a carbon-carbon double bond in the third position from the end of the carbon chain. From a nutritional standpoint, the most important omega-3 fatty acids are probably α-linolenic acid (“ALA”), eicosapentaenoic acid (“EPA”), and docosahexaenoic acid (“DHA”). ALA is an 18-carbon fatty acid moiety having three carbon-carbon double bonds (commonly referred to as C18:3 in shorthand notation), one of which is at the n-3 position. EPA is a 20-carbon fatty acid moiety having 5 carbon-carbon double bonds (“C20:5”) and DHA is a 22-carbon fatty acid moiety having 6 carbon-carbon double bonds (“C22:6”).

Unfortunately, ALA, EPA, and DHA are all polyunsaturated fats that tend to oxidize, and thus rancidify, fairly readily. EPA (with 5 carbon-carbon double bonds) is significantly more prone to oxidation than ALA; DHA (with 6 carbon-carbon double bonds) is even more prone to oxidation than EPA. As a consequence, increasing the omega-3 fatty acid content tends to reduce the shelf life of many food products. These problems become particularly acute with oils including significant amounts of EPA and DHA.

To address rancidification of edible oils and fats, it is known in the art to use antioxidant compositions. Due to consumer demands, there is an increasing need to replace synthetic antioxidant with natural antioxidants in different food systems. However, incorporation of natural antioxidants into edible oils (as bulk oil) is challenging, since effective natural antioxidants may be water-soluble rather than oil-soluble, and thus precipitate during oil storage.

### SUMMARY

In one aspect, provided is a stabilized canola oil including a canola oil and an antioxidant composition, where the canola oil includes polyunsaturated fatty acids selected from the group consisting of EPA and DHA, and the antioxidant composition comprises rosemary extract and least one of green tea extract, lecithin, and sesamol.

In another aspect, provided are methods for preparing a stabilized canola oil, the method comprising providing a canola oil, and adding an antioxidant composition to the canola oil to provide a stabilized canola oil, where canola oil includes polyunsaturated fatty acids selected from the group consisting of EPA and DH, and the antioxidant composition comprises rosemary extract and least one of green tea extract, lecithin, and sesamol.

### DETAILED DESCRIPTION

Stabilized canola oils and methods of stabilizing canola oils are disclosed. As described herein, stabilized canola oils can be prepared by adding an antioxidant composition to a canola oil, the antioxidant composition comprising rosemary extract and least one of green tea extract, lecithin, and sesamol.

### Canola Oil

As used herein, the term “canola oil” means an oil derived from a Brassica napus plant which produces seed that yields oil having less than 2% erucic acid and meal that contains no more than 30 micromoles of the following glucosinolates per gram of air-dry, oil-free solid: 3-butenyl glucosinolate, 4-pentenyl glucosinolate, 2-hydroxy-3 butenyl glucosinolate, and 2-hydroxy-4-pentenyl glucosinolate. The canola oil may include one or more omega-3 fatty acids, such as, for example, α-linolenic acid (“ALA”), docosahexaenoic acid (“DHA”), eicosapentaenoic acid (“EPA”), and stearidonic acid (“SDA”).

As used herein, the term “vascular plant” refers to a plant having the vascular tissues xylem and phloem. In some embodiments, the DHA and EPA in the canola oil are produced by a vascular plant. In some embodiments, the vascular plant selected from the plant family Brassicaceae. In some embodiments, the vascular plant is a canola plant.

In some embodiments, the canola oil may include at least 0.05 wt. %, at least 0.1 wt. %, at least 0.2 wt. %, at least 0.3 wt. %, at least 0.4 wt. %, at least 0.5 wt. %, at least 0.6 wt. %, at least 0.7 wt. %, at least 0.8 wt. %, at least 0.9 wt. %, at least 1 wt. %, at least 1.5 wt. %, at least 2 wt. %, at least 2.5 wt. %, at least 3 wt. %, at least 3.5 wt. %, at least 4 wt. %, at least 4.5 wt. %, at least 5 wt. %, at least 5.5 wt. %, at least 6 wt. %, at least 6.5 wt. %, at least 7 wt. %, at least 7.5 wt. %, at least 8 wt. %, at least 8.5 wt. %, at least 9 wt. %, at least 9.5 wt. %, at least 10 wt. %, at least 12 wt. %, at least 14 wt. %, at least 16 wt. %, at least 18 wt. %, at least 20 wt. %, at least 22 wt. %, at least 24 wt. %, at least 26 wt. %, or at least 28 wt. % combined EPA and DHA.

In some embodiments, the canola oil may be a refined oil. The term “refined oil” refers to a vegetable oil which has undergone a refining process. Refining is a process in which unwanted constituents are removed from an oil. Oils can be refined to varying degrees, and it is the desired quality of the refined oil which determines the degree of refining. Additionally, depending upon the properties of the oil desired, different processing steps can be included. Processes of refining oils are well known in the art; an exemplary description of a refining process is provided in Perkins et al., Deep Frying: Chemistry, Nutrition, and Practical Applications, pp. 12-24, AOCS Press, 1996.

### Antioxidant Compositions

Antioxidant compositions of the present disclosure include a rosemary extract containing 20-24 wt % carnosic acid. Rosemary extracts that may be useful in embodiments of the present disclosure are available commercially from Naturex SA, Avignon, France under the trade name STABILENHANCE OSR 20.

In some embodiments, the stabilized canola oil may comprise at least about 725 ppm, at least about 750 ppm, at least about 775 ppm, at least about 800 ppm, at least about 825 ppm, at least about 850 ppm, at least about 875 ppm, at least about 900 ppm rosemary extracts, at least about 1,000 ppm, at least about 1,500 ppm, or at least about 2,000 ppm rosemary extracts. In some embodiments, the stabilized canola oil may comprise less than about 6,500 ppm, less than about 5,500 ppm, 4,500 ppm, less than about 3,000 ppm, less than about 2,000 ppm, less than about 1,750 ppm, less than about 1,725 ppm, less than about 1,700 ppm, or less than about 1,675 ppm rosemary extracts. In some embodiments, the stabilized canola oil may comprise about 725 ppm to about 6,000 ppm rosemary extracts, about 750 ppm to about 5,000 ppm rosemary extracts, about 775 ppm to about 4,000 ppm rosemary extracts, about 800 ppm to about 3,000 ppm rosemary extracts, about 825 ppm to about 2,900 ppm rosemary extracts, about 850 ppm to about 2,800 ppm rosemary extracts, about 875 ppm to about 2,700 ppm rosemary extracts, or about 900 ppm to about 2,600 ppm rosemary extracts. In some embodiments, the stabilized canola oil may comprise about 1,000 to about 2500 ppm rosemary extracts. In some embodiments, the stabilized canola oil may comprise about 1,000 ppm rosemary extracts. In some embodiments, the stabilized canola oil may comprise about 2,000 ppm rosemary extracts. In some embodiments, the stabilized canola oil may comprise about 2,500 ppm rosemary extracts.

Green tea extracts are known to contain compounds having antioxidant activity. Green tea extracts suitable for use in embodiments of the present disclosure are commercially available under the trade name GT-FORT 101 SF from Kemin Industries, Inc., Des Moines, Iowa, USA. In some embodiments, the stabilized canola oil may comprise at least about 400 ppm, at least about 500 ppm, at least about 600 ppm, at least about 700 ppm, at least about 800 ppm, or at least about 900 ppm green tea extract. In some embodiments, the stabilized canola oil may comprise less than about 4,500 ppm, less than about 4,000 ppm, less than about 3,800 ppm, less than about 3,600 ppm, less than about 3,400 ppm, or less than about 3,200 ppm green tea extract. In some embodiments, the stabilized canola oil may comprise about 400 ppm to about 1,600 ppm green tea extract, about 500 ppm to about 1,500 ppm green tea extract, about 600 ppm to about 4,500 ppm green tea extract, about 700 ppm to about 4,000 ppm green tea extract, about 800 ppm to about 3,800 ppm green tea extract, or about 900 ppm to about 3,600 ppm green tea extract. In some embodiments, the stabilized canola oil may comprise about 2,500 ppm to about 3,500 ppm green tea extract. In some embodiments, the stabilized canola oil may comprise about 3,000 ppm green tea extract.

Lecithins are compositions found in plants and animals; they commonly include, among other compounds, phosphatidylcholine, phosphatidylethanolamine, and phosphatidylinositol. Lecithins are used industrially for their emulsifying properties and are known to contribute to the oxidative stability of oils and fats. Lecithins useful in embodiments of the present disclosure may be derived from plant sources, such as, for example, sunflower, soy, and canola. Lecithin suitable for use in embodiments of the present disclosure are commercially available from Connoils LLC, Waukesha, Wis., USA. Soy lecithin suitable for use in embodiments of the present disclosure are commercially available under the trade name TOPCITHIN UB from Cargill, Incorporated, Wayzata, Minn., USA. In some embodiments, the stabilized canola oil may comprise at least about 400 ppm, at least about 500 ppm, at least about 600 ppm, at least about 700 ppm, at least about 800 ppm, or at least about 900 ppm lecithin. In some embodiments, the stabilized canola oil may comprise less than about 9,000 ppm, less than about 8,500 ppm, less than about 8,000 ppm, less than about 7,500 ppm, less than about 7,000 ppm, or less than about 6,500 ppm lecithin. In some embodiments, the stabilized canola oil may comprise about 400 ppm to about 9,000 ppm lecithin, about 500 ppm to about 8,500 ppm lecithin, about 600 ppm to about 8,000 ppm lecithin, about 700 ppm to about 7,500 ppm lecithin, about 800 ppm to about 7,000 ppm lecithin, or about 900 ppm to about 6,500 ppm lecithin. In some embodiments, the stabilized canola oil may comprise about 5,500 ppm to about 6,500 ppm lecithin. In some embodiments, the stabilized canola oil may comprise about 6,000 ppm lecithin.

Sesamol (1,3-Benzodioxol-5-ol) is an antioxidant that is found in sesame oil. Sesamol is commercially available from Sigma-Aldrich Corporation, St. Louis, Mo., USA. In some embodiments, the stabilized canola oil may comprise at least about 200 ppm, at least about 250 ppm, at least about 300 ppm, at least about 350 ppm, at least about 400 ppm, at least about 450 ppm, or at least about 500 ppm sesamol. In some embodiments, the stabilized canola oil may comprise less than about 4,500 ppm, less than about 4,000 ppm, less than about 3,500 ppm, less than about 3,250 ppm, less than about 3,000 ppm, less than about 3,800 ppm, or less than about 3,600 ppm sesamol. In some embodiments, the stabilized oil may comprise about 200 ppm to about 4,500 ppm sesamol, about 250 ppm to about 3,500 ppm sesamol, about 300 ppm to about 3,250 ppm sesamol, about 3,000 ppm to about 850 ppm sesamol, or about 400 ppm to about 3,000 ppm sesamol. In some embodiments, the stabilized oil may comprise about 2,250 ppm to about 2,750 ppm sesamol. In some embodiments, the stabilized oil may comprise about 2,500 ppm sesamol.

### Stabilized Oil

In one aspect, stabilized canola oils of the present disclosure include an antioxidant mixture comprising rosemary extract and least one of green tea extract, lecithin, and sesamol.

In some embodiments, the antioxidant mixture may include rosemary extract and green tea extract. In some embodiments, the stabilized oil may include about 2,500 ppm rosemary extract, and about 1,000 ppm to about 3,500 ppm green tea extract. In some embodiments, the stabilized oil may include about 2,500 ppm rosemary extract, and about 2,500 ppm green tea extract. In some embodiments, the stabilized oil may include about 2,500 ppm rosemary extract, and about 3,000 ppm green tea extract.

In some embodiments, the antioxidant mixture may include rosemary extract and lecithin. In some embodiments, the stabilized oil may include about 1,000 ppm rosemary extract, and about 600 ppm to about 6,000 ppm lecithin. In some embodiments, the stabilized oil may include about 1,000 ppm rosemary extract, and about 1,200 ppm to about 6,000 ppm lecithin. In some embodiments, the stabilized oil may include about 1,000 ppm rosemary extract, and about 3,000 ppm lecithin.

In some embodiments, the antioxidant mixture may include rosemary extract and sesamol. In some embodiments, the stabilized oil may include about 1,000 ppm rosemary extract, and about 600 ppm to about 6,000 ppm sesamol. In some embodiments, the stabilized oil may include about 2,000 ppm rosemary extract, and about 1,000 ppm to about 3,000 ppm sesamol. In some embodiments, the stabilized oil may include about 2,000 ppm rosemary extract, and about 2,500 ppm sesamol.

Stabilized oils of the present disclosure may have an Oxidative Stability Index (“OSI”) at 110° C. (American Oil Chemists' Society test protocol AOCS Cd 12b-92) of at least about 5 hours, at least about 5.5 hours, at least about 6 hours, at least about 6.5 hours, at least about 7 hours, at least about 7.5 hours, at least about 8 hours, at least about 8.5 hours, at least about 9 hours, at least about 9.5 hours, at least about 10 hours, at least about 10.5 hours, at least about 11 hours, at least about 11.5 hours, or at least about 12 hours.

Stabilized oils of the present disclosure may be free of visible precipitation of added antioxidants for at least one week, two weeks, three weeks, one month, two months, three months, four months, five months, six months, one year, eighteen months, two years, or three years.

### Stabilizing an Edible Oil

In another aspect, provided are methods of preparing a stabilized canola oil. In some embodiments, the method includes providing a canola oil including EPA and/or DHA and adding to the canola oil an oil-soluble antioxidant composition, where the antioxidant composition comprises rosemary extract and least one of green tea extract, lecithin, and sesamol.

Methods of combining edible oils with other materials, such as, for example, an oil-soluble antioxidant composition including rosemary extract and least one of green tea extract, lecithin, and sesamol are known to those of ordinary skill in the relevant arts.

In some embodiments, the antioxidant composition may be added to an edible oil at room temperature (e.g., about 23° C.). In some embodiments, the antioxidant composition may be added to a heated edible oil, for example, a canola oil heat from about 23° C. to about 60° C.

In some embodiments, the antioxidant composition including rosemary extract and least one of green tea extract, lecithin, and sesamol may be prepared as a mixture prior to addition to the canola oil.

In some embodiments, the rosemary extract and least one of green tea extract, lecithin, and sesamol may be added sequentially to the edible oil, e.g., the rosemary extract may be added first to the edible oil, followed by the addition of at least one of green tea extract, lecithin, and sesamol, or at least one of green tea extract, lecithin, and sesamol may be added first to the edible oil, followed by the addition of rosemary extract. In some embodiments, the rosemary extract may be added during the addition of at least one of green tea extract, lecithin, and sesamol to the canola oil.

The concentrations and types of rosemary extract, green tea extract, lecithin, and sesamol which can be added to a canola oil to yield a stabilized oil are those described above for the stabilized oil.

The addition of rosemary extract and least one of green tea extract, lecithin, and sesamol to a canola oil provides an oil which shows surprisingly enhanced stabilization in OSI testing. This effect can be best examined when the stabilized oil of the present disclosure is compared to the same edible oil without the addition of rosemary extract and least one of green tea extract, lecithin, and sesamol after both are heated for extended periods of time. In the subsequent Example section, this benefit is exemplified in Examples 1, 2, and 3, which show the difference in OSI value of a canola oil without added rosemary extract and least one of green tea extract, lecithin, and sesamol and the OSI value of a canola oil to which rosemary extract and least one of green tea extract, lecithin, and sesamol have been added before heating.

### EXAMPLES

Aspects of certain embodiments in accordance with aspects of the disclosure are illustrated in the following Examples. The materials and methods described in these Examples are illustrative and not intended to be limiting.

### Experimental Procedures

Oxidative Stability Index (“OSI”): The OSI measurements were carried out in accordance with AOCS Cd 12b-92 at 110° C. with a 743 RANCIMAT analyzer (Metrohm AG, Herisau, Switzerland) generally in accordance with American Oil Chemists' Society test protocol AOCS Cd 12b-92, except that the sample size of the oil is 3.0 g.

### Materials

Canola oil including 0.66 wt % DHA and 4.66 wt % EPA, the EPA and DHA both produced by a canola plant; STABILENHANCE OSR 20, a rosemary extract containing 20-24 wt % carnosic acid, available from Naturex SA, Avignon, France; GT-FORT 101 SF, a green tea extract, available from Kemin Industries, Inc., Des Moines, Iowa, USA; TOPCITHIN UB, a soy lecithin, available from Cargill, Incorporated, Wayzata, Minn., USA; and sesamol (1,3-Benzodioxol-5-ol) available from Sigma-Aldrich Corporation, St. Louis, Mo., USA.

### Example 1: OSI of Canola Oil Including Antioxidant Compositions

Canola oil including 0.66 wt % DHA and 4.66 wt % EPA, the EPA and DHA both produced by a canola plant, is combined with antioxidant to provide oil samples having antioxidant concentrations as shown in Tables 1 and 2. OSI testing was performed on each of the samples as set forth above. The results of the OSI tests are set forth in Tables 1 and 2.

TABLE 1
OSI of Canola Oil with Added Rosemary
or Green Tea Extract Antioxidant

| Antioxidant | 0 ppm | 1000 ppm | 2000 ppm | 3000 ppm | 4000 ppm |
|---|---|---|---|---|---|
| OSI with | 3.82375 | 4.775 | 7.26 | 8.635 | 8.425 |
| Rosemary | | | | | |
| OSI with | 3.82 | 4.30 | 5.15 | 6.26 | 7.04 |
| Green Tea | | | | | |

TABLE 2
OSI of Canola Oil with Added Rosemary and Green Tea Extract

| | Rosemary/Green Tea (ppm) | | | | | | |
|---|---|---|---|---|---|---|---|
| | 2500/ | 2500/ | 2500/ | 2500/ | 2500/ | 2500/ | 2500/ |
| | 0 | 1000 | 2000 | 2500 | 3000 | 3500 | 4000 |
| OSI | 4.78 | 10.50 | 10.70 | 11.83 | 12.01 | 11.23 | 10.235 |

As shown in Tables 1 and 2, the OSI of a canola oil with added antioxidants is greater than the oil without added antioxidant. Surprisingly, as shown in Table 2, the antioxidant mixture of rosemary extract and green tea extract provided the best stability to the canola oil at concentrations of 2500 ppm and 3000 ppm respectively.

### Example 2: OSI of Edible Oils Including Antioxidant Compositions

Canola oil including 0.66 wt % DHA and 4.66 wt % EPA, the EPA and DHA both produced by a canola plant, is combined with antioxidant to provide oil samples having antioxidant concentrations as shown in Tables 3 and 4. OSI testing was performed on each of the samples as set forth above. The results of the OSI tests are set forth in Tables 1 and 2.

TABLE 3
OSI of Canola Oil with Added Soy Lecithin

| | 0 | 600 | 1200 | 1800 | 2400 | 3000 | 6000 |
|---|---|---|---|---|---|---|---|
| | ppm | ppm | ppm | ppm | ppm | ppm | ppm |
| OSI with Soy | 2.73 | 3.43 | 4.45 | 6.34 | 5.54 | 6.84 | 11.26 |
| Lecithin | | | | | | | |

TABLE 4
OSI of Canola Oil with Added Rosemary and Soy Lecithin

| | Rosemary/Soy Lecithin (ppm) | | | | | | |
|---|---|---|---|---|---|---|---|
| | 1000/ | 1000/ | 1000/ | 1000/ | 1000/ | 1000/ | 1000/ |
| | 0 | 600 | 1200 | 1800 | 2400 | 3000 | 6000 |
| OSI | 3.4 | 5.48 | 8.17 | 9.14 | 10.56 | 12.09 | 12.81 |

As shown in Tables 3 and 4, the OSI of a canola oil with added antioxidants is greater than the oil without added antioxidant. Surprisingly, as shown in Table 4, the antioxidant mixture of rosemary extract and soy lecithin provided the best stability to the canola oil at concentrations of 1000 ppm and 6000 ppm respectively.

### Example 3: OSI of Edible Oils Including Antioxidant Compositions

Canola oil including 0.66 wt % DHA and 4.66 wt % EPA, the EPA and DHA both produced by a canola plant, is combined with antioxidant to provide oil samples having antioxidant concentrations as shown in Tables 5 and 6. OSI testing was performed on each of the samples as set forth above. The results of the OSI tests are set forth in Tables 1 and 2.

TABLE 5
OSI of Canola Oil with Added Sesamol

| | 0 ppm | 600 ppm | 1200 ppm | 1800 ppm | 2400 ppm |
|---|---|---|---|---|---|
| OSI with | 2.73 | 3.43 | 4.45 | 6.34 | 5.54 |
| Sesamol | | | | | |

TABLE 6
OSI of Canola Oil with Added Rosemary and Sesamol

| | Rosemary/Sesamol (ppm) | | | | | | |
|---|---|---|---|---|---|---|---|
| | 2000/ | 2000/ | 2000/ | 2000/ | 2000/ | 2000/ | 2000/ |
| | 0 | 1000 | 2000 | 2500 | 3000 | 3500 | 4000 |
| OSI | 7.69 | 6.4 | 9.03 | 10.04 | 9.01 | 7.94 | 8.12 |

As shown in Tables 5 and 6, the OSI of a canola oil with added antioxidants is greater than the oil without added antioxidant. Surprisingly, as shown in Table 6, the antioxidant mixture of rosemary extract and sesamol provided the best stability to the canola oil at concentrations of 2000 ppm and 2500 ppm respectively.

What is claimed is:

1. A stabilized canola oil comprising:
a canola oil; and
an oil-soluble antioxidant composition,
wherein the canola oil comprises a polyunsaturated fat selected from the group consisting EPA and DHA, wherein the EPA and/or DHA are derived from a vascular plant source, and wherein the oil-soluble antioxidant composition comprises rosemary extract and least one of green tea extract, lecithin, and sesamol.

2. The stabilized oil of claim 1, wherein the stabilized oil has a rosemary extract concentration of from about 1,000 ppm to about 2,500 ppm.

3. The stabilized oil of claim 2, comprising from about 1,000 ppm to about 3,500 ppm green tea extract.

4. The stabilized oil of claim 2, comprising from about 1,200 ppm to about 6,000 ppm lecithin.

5. The stabilized oil of claim 2, comprising from about 1,000 ppm to about 3,000 ppm sesamol.

6. The stabilized oil of claim 2, wherein the stabilized oil has an Oxidative Stability Index at 110° C. of at least 5 hours.

7. The stabilized oil of claim 3, wherein the stabilized oil has an Oxidative Stability Index at 110° C. of at least 10 hours.

8. The stabilized oil of claim 4, wherein the stabilized oil has an Oxidative Stability Index at 110° C. of at least 10 hours.

9. The stabilized oil of claim 5, wherein the stabilized oil has an Oxidative Stability Index at 110° C. of at least 8 hours.

10. A method for preparing a stabilized oil, the method comprising:
providing a canola oil comprising a polyunsaturated fat selected from the group consisting of EPA and DHA, wherein the EPA and/or DHA are derived from a vascular plant source; and
adding an antioxidant composition comprising rosemary extract and least one of green tea extract, lecithin, and sesamol to the canola oil to yield a stabilized oil.

11. The method of claim 10, wherein the stabilized oil has a rosemary, extract concentration of from about 1,000 ppm to about 2,500 ppm.

12. The method of claim 11, comprising from about 1,000 ppm to about 3,500 ppm green tea extract.

13. The method of claim 11, comprising from about 1,200 ppm to about 6,000 ppm lecithin or from about 1,000 ppm to about 3,000 ppm sesamol.

14. The method of claim 11, wherein the stabilized oil has an Oxidative Stability Index at 110° C. of at least 5 hours.

15. The method of claim 12, wherein the stabilized oil has an Oxidative Stability Index at 110° C. of at least 10 hours.
